(19) United States
(12) Patent Application Publication
(10) Pub. No.: US 2008/0260153 A1
(43) Pub. Date: Oct. 23, 2008

(54) Symmetric and asymmetric cryptography using shadow numbers

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/738,446

(22) Filed: Apr. 20, 2007

(51) Int. Cl. H04L 9/00

(52) U.S. Cl. 380/259

(57) ABSTRACT

A method and an apparatus for enciphering and deciphering content with symmetric and asymmetric cryptography with the use of the shadow numbering system where two or more shadow values are used with two or more base values with a two side equation, on one side the value to encipher is multiplied with one of the shadow value then the modulus taken with the base value, to decipher the enciphered value is multiplied with the shadow value that didn't take part of the first equation then the modulus is taken with the base value, thus, deciphering the enciphered value.

### BACKGROUND OF INVENTION

1. Field of the Invention

The field of this invention relates to symmetric and asymmetric cryptography with the use of the shadow numbering system.

2. Prior Art

Hellman, et al U.S. Pat. No. 4,200,770 teaches a cryptographic system that transmits a computationally secure cryptogram over an insecure communication channel without prearrangement of a cipher key. The conversers from transformations of exchanged transformed signals generate a secure cipher key. The conversers each possess a secret signal and exchange an initial transformation of the secret signal with the other converser. The received transformation of the other converser's secret signal is again transformed with the receiving converser's secret signal to generate a secure cipher key. The transformations use non-secret operations that are easily performed but extremely difficult to invert. It is infeasible for an eavesdropper to invert the initial transformation to obtain either converser's secret signal, or duplicate the latter transformation to obtain the secure cipher key.

Hellman, et al U.S. Pat. No. 4,200,770 teaches a cryptographic apparatus where two parties can safely exchange secured data through insecure channel without prior knowledge of the parties-common secret key. Hellman's U.S. Pat. No. 4,200,770 fails to teach however a common denominator in deriving the cryptographic keys without a laborious and expensive means for deriving the large-prime numbers values.

There are other means of encryption algorithm as well and they are the public key where two keys are used, a private and a public, the intended recipient of the cipher text that encrypted only knows the public key by the private key equivalent. One of the most popular public key algorithms is the RSA algorithm, named after its three inventors—Ron Rivest, Adi Shamir, and Leonard Adleman a message M and encrypts it using the formula C=ME mod N, where N is the product of two large primes numbers P, Q chosen at random. The exponent E is a number relatively prime to (P−1)(Q−1). The encrypted message C is deciphered using the formula M=CD mod N where D=E−1 mod((p−1)(q−1)). The exponent E and modulus N are used as the public key. The exponent D is the private key. The primes P and Q are not needed once the public and private keys have been computed but should remain secret.

RSA algorithm U.S. Pat. No. 4,405,829 as with Hellman's algorithm fails to teach a simple means for deriving the cryptographic keys and fails to teach an easy and inexpensive means for producing symmetric and asymmetric cryptographic means that is easy and inexpensive to implement in software and hardware alike, it further fails to teach a secure means where values other than prime numbers can be used in cryptographic process.

It is the objective of the present invention to teach a cryptographic method and apparatus where symmetric, asymmetric and other encryption means are produced from the same base algorithm without requiring sophisticated and expensive means for their implementation and use.

### SUMMARY OF THE INVENTION

Illustrated herein a method and an apparatus to encipher and decipher data using shadow-numbering system where a two equation is used with a common modulus value for two shadow numbers values. The value to encipher is multiplied with one of the shadow value the modulus is taken between the product and the shadow value, to decipher, the enciphered value is multiplied with the other shadow value and the modulus taken with the base value.

Any two values can be considered a shadow pair and once two-shadow values are multiplied and one subtracted from the product, then the subtracted result divided by any other value that it can be divided with will produce the base value for the shadow-pair values.

Any value as the base value and once one is added to and the result divided by any value that it can be divided with will produce two-shadow values for the base value.

A shadow-pair value can have multiple base values, the same applies to the base value, a base value can have multiple shadow-values pair.

By adding the base value to each of the shadow values and raising all three values to a common power value (exponentially), one of the shadow value and the modulus of the raised base value are used for enciphering public key and the other shadow value with the modulus of the original base value are used for the deciphering private key. By multiplying a new value to the base and using one of the new shadow values along with the original base value (first raised base value) creates a new deciphering key for deciphering enciphered data with the private key. The second new shadow value along with the new base value is used for the private enciphering-key pair.

Each value participating in the creation of the base value will be a base, and each value participating in the creation of the shadow-pair will be a shadow-pair for each of the base. Values enciphered with one base can be deciphered with itself or with lower base values. The enciphering and deciphering values must be from one to the lowest base taking part of the enciphering and deciphering process minus one.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates the shadow axis having two shadow values and the base axis having three base values related to the two shadow values.

FIG. 2 illustrates a further embodiment of FIG. 1 where the base value of “2” along with a table showing the shadow's value of “3” and “5” being used for enciphering and deciphering the value of “1”.

FIG. 3 illustrates a further embodiment of FIG. 1 where the base value of “7” along with a table showing the shadow's value of “3” and “5” being used for enciphering and deciphering the values of “1-6”.

FIG. 4 illustrates a further embodiment of FIG. 1 where the base value of “14” along with a table showing the shadow's value of “3” and “5” being used for enciphering and deciphering the values of “1-13”.

FIG. 5 illustrates a further embodiment of FIG. 1 where three base values takes part of the shadow value composite and it is the multiplication of “5” and “3” in which the value of “15” is derived and its companion is the value of “1”.

FIG. 6 illustrates multiple base and multiple shadow used for enhanced cryptographic means.

FIG. 7 illustrates the arrangement of FIG. 6 used for email certification.

FIG. 8 illustrates private/public shadow key assigned to user at registration time.

FIG. 9 illustrates a online voting solution using shadow cryptography.

FIG. 10 illustrates an apparatus for processing the enciphering/deciphering of data in which the shadow-base mathematical values as used.

FIG. 11 illustrates a further embodiment of FIG. 10 wherein the encode/decode modules are depicted thereon.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method or a computer program product. Accordingly, the present invention may take a form of an entirely software embodiment or an embodiment combining software and hardware. Furthermore, the present invention may take the form of a computer program product on a computer-readable storage medium having computer-readable program code means embodied in the medium. Any computer readable medium may be utilized including but not limited to: hard disks, CD-ROMS, optical storage devices, magnetic devices, etc.

Furthermore, any reference to names of a product or of a company is for the purpose of clarifying our discussion and they are registered to their respective owners.

It is the object of the present invention to offer an easy and inexpensive means for producing symmetric and asymmetric encryption without the complexity that is currently available making exclusive use of prime numbers and exponentiation.

As well it is a further object of the present invention to offer a simple solution where using simple multiplication once, thus, offering a secure and inexpensive solution and the use of a single algorithm for all cryptographic needs on hardware and software with low cost and high speed.

In another embodiment of the present invention a method and an apparatus will be taught and it is a means for transmitting a key/password over insecure channel without the possibility of the deciphering of its content by an eavesdropper. A first signal containing the key/password to be transmitted is transposed with an additional random signal value and the intended signal along with the random signal is transmitted to the receiver and the receiver will transpose a second random signal and return to the sender the two random signals along with the intended signal's message. The sender will remove the first random signal that was inserted by said sender apparatus and transmit the second random signal along with the intended signal's message, upon receiving the two remaining signals the receiver will remove the second random signal that as transposed by said receiver and the intended signal's message is retrieved.

### Encryption With Shadow Numbers

Through the ages mathematicians have been puzzled and thrilled, puzzled with the secret of numbers and thrilled with the infinite possibilities that the science of mathematics has to offer. From time to time new ways of using numbers and new numbering system is discovered, thus revealing a new infinity of possibilities that can be mind boggling, since in mathematics or in any other science for that matter, everything is in the hidden to be discovered, analyzed and expanded.

In the field of encryption, new algorithms are found and used in the science of the ability to cipher and decipher information with the use of mathematical formulas and to some extent they all use the science of the shadow numbers. There are two types of encryption algorithm, symmetric (private) and asymmetric (public).

The symmetric scheme uses a single key called the private key and it is used both, to encrypt and decrypt. The private key must be kept private all the time that is, kept secret, since only one key is used and anyone in possession of it will be able to cipher (encrypt) and decipher (decrypt) the message that is associated with it.

Asymmetric scheme is when two keys are used, one for enciphering and the other for deciphering the content, there is, the public and the private encryption-keys pair. The public key as its name implies, it is to be used by anyone who comes across it and it works in conjunction with its equivalent private key. The public key is used for enciphering the content and the private key equivalent of the public key is used for deciphering the enciphered content.

An asymmetric scheme has others advantages as well and it can be viewed as a two-way lane one for each direction, that is, the private key can be used for enciphering as well and the public key equivalent to the private key for deciphering what was enciphered with the private key. This way the private key can encipher content to a group of recipients and everyone in possession of the public key equivalent to the private key can decipher it; this process happens when the sender—holder of the private—sends a message to the group having the public key.

In general, the asymmetric scheme is slower than its symmetric counterpart, in a great number of situations a combination of both schemes is used for the purpose of security and speed. The symmetric scheme is used to encipher the content and the asymmetric one is used to encipher the content's key. This way, best of the two worlds are achieved. The symmetric scheme encrypts the content and produces the content's key and the asymmetric scheme encrypts the content's key.

The asymmetric scheme involves mathematical formulas and in most cases dealing with numerical exponentiations which requires a great deal of computation power on both ends, for enciphering and deciphering. The way that the asymmetric scheme works is by providing two or more formulas for the creation of the two-key combination, for enciphering and deciphering. The two-key pair and the two keys in turns produce mathematical values equivalent to each other as if they were the shadow of one another.

### From Now on Shadow Numbers

It is the desire for an asymmetric scheme to offer the best of the best in security and speed in a single algorithm and it is what the shadow numbering system is all about and henceforth it will fully explained.

Whenever two numbers are multiplied and “1” is subtracted from their product then the result divided by any number that it is dividable with, the shadow-triplet numbers will be uncovered. Lets explain this process step-by-step.
1) Lets pick two numbers: 5 and 3.
2) Now we multiply them: 5×3=15.
3) And subtract 1 from: 15−1=14.
4) Divide by any number that is dividable with: 17/2=7.
5) We have a shadow triplet: 5 mod 7 and 3 mod 7; 5 and 3 are the shadow values and 7 the shadows' base value.

Lets proceed and further explore the shadow triplet that we've just discovered. In any direction we start and multiply a number starting with the number one and up to the base minus one—six in our explanation—then take the modulus with the base number and as we go around from one side of the equation to the other one and performing the same operation, we will get the starting value. Lets explore it now.
a) 1×5 mod 7=5=>5×3 mod 7=1−the reverse is true as well−1×3 mod 7=3=>3×5 mod 7=1.
b) 2×5 mod 7=3=>3×3 mod 7=2−the reverse is true as well−2×3 mod 7=6=>6×5 mod 7=2.
c) 3×5 mod 7=1=>1×3 mod 7=3−the reverse is true as well−3×3 mod 7=2=>2×5 mod 7=3.
d) 4×5 mod 7=6=>6×3 mod 7=4−the reverse is true as well−4×3 mod 7=5=>5×5 mod 7=4.
e) 5×5 mod 7=4=>4×3 mod 7=5−the reverse is true as well−5×3 mod 7=1=>1×5 mod 7=5.
f) 6×5 mod 7=2=>2×3 mod 7=6−the reverse is true as well−6×3 mod 7=4=>4×5 mod 7=6.

Based on the above explanation it can be said that: 5 mod 7 is a shadow of 3 mod 7 and vice versa.

We've used the product of two-shadow numbers to discover their equivalent base number, then have the shadow-triplet numbers formed, the two shadow numbers in our example happen to be primes, as we'll see, this is not a requirement, it can be any number combination. Primes as best since they produce single base values, although any value will do it, their corresponding byproduct will be the shadow's base as well, for instance, the value of 21 will have 7 and 3 as the base as well because 21 is the byproduct of the primes 3 and 7.

As we might notice, the above triplet has a major flaw since the two shadows are smaller than the base and this will have a very limited use in the science of cryptography. It has a remedy and will show it. If we add the base value to the other two shadow values; the shadow will still be linear in relation to the base. A few examples will make this clear. Lets add “7” to “5” and we get “12” and add “7” to “3” and we'll get “10”. Lets now repeat the above example, except this time we'll be using the new values.
a) 1×12 mod 7=5=>5×10 mod 7=1−the reverse is true as well−1×10 mod 7=3=>3×12 mod 7=1.
b) 2×12 mod 7=3=>3×10 mod 7=2−the reverse is true as well−2×10 mod 7=6=>6×12 mod 7=2.
c) 3×12 mod 7=1=>1×10 mod 7=3−the reverse is true as well−3×10 mod 7=2=>2×12 mod 7=3.
d) 4×12 mod 7=6=>6×10 mod 7=4−the reverse is true as well−4×10 mod 7=5=>5×12 mod 7=4.
e) 5×12 mod 7=4=>4×10 mod 7=5−the reverse is true as well−5×10 mod 7=1=>1×12 mod 7=5.
f) 6×12 mod 7=2=>2×10 mod 7=6−the reverse is true as well−6×10 mod 7=4=>4×12 mod 7=6.

The last enhancement is a little more appealing than the previous one.

### Shadow Numbers, The Soul of Encryption

Private Key—The interesting thing with the shadow number is the ability of simplified calculation and because of their simplicity speed is a factor to be considered as well. As anyone with mathematical skills will notice the above example could be used for a simple encryption, security is just another matter that will be addressed shortly.

It could've been used in conjunction with other schemes thus having its security increased that way, for instance, if used with Diffie-Hellman for the common key exchange, then having two common keys exchanged and if any of them happen to be even number, have one added to, thus converting to an odd number. Next, by applying the same method aforementioned and have the shadow-triplet numbers created, finally, have them as the encryption mechanism for transferring cipher data. The advantage of such a combination is speed and since the shadow triplet will be totally hidden from an eavesdropper, its security will lie in the difficulty deriving the three vales instead of just one. Shadow-number triplet can be used as any other numbering system; they can be multiplied, raised to their powers, added to and subtracted from, as well.

The shadow triplets can be raised to the power of another value to produce larger and safer values. Lets now raise the above triple of the last example to the power of 3: 12̂3 mod 7̂3=>1728 mod 343 and 10̂3 mod 7 =>1000 mod 7. Now, this last schema can be used as a asymmetric encryption, the encryption key is: 1728 mod 343 and the decryption key is: 1000 mod 7; the reverse can be true as well and the encryption key can be: 1000 mod 343 and de decryption key can be: 1728 mod 7, either way will work. The last arrangement will offer more security since anyone using brute force attack will need to start from the known shadow value, which is from the lowest to the highest value.

Once again, in our examples we're using small values, actually, much large values having hundreds of positions will be used for all the three values. The base value designate how large the value to be ciphered, in all three examples, the values to cipher will be from “1” to “6”. The value of “0” cannot be used in the ciphering and there is a solution for such, just add the value of “1” for each value to be enciphered and have “1” subtracted from the deciphered values, the original values is thus reproduced.

This schema can be called one way encryption since the enciphering only happens from the sender to the receiver and in a lot of cases the sender and receiver can exchange their respective public keys and have a safe two-way communication, it can be used instead of, or be a replacement for Diffie-Hellman algorithm.

In our modern time and with all the security requirements, it is quite obvious that in most of the time security involves more than just two individuals and a more elaborate means for enciphering and deciphering content in a two-way multiparty environment is required. Thus requiring a more sophisticated enciphering schema in which the aforementioned private schema lacks. The next section we'll will explore a more elaborate one to solve this problem.

Public Key—Once explaining the private key schema we started from the dual-shadow values by multiplying them then subtracting one from it then dividing the result by two to get a third value, the shadow base value. For the public key schema we'll start from the base value side to derive the two-shadow value pair.

As we analyze the prior example, we'll notice that the triplet values can be used in more than one way, we've seen two, the first one, that is, the original values were: “5 mod 7 and 3 mod 7”; the second one we added the base to each 16 shadow and the triplet became: “12 mod 7 and 10 mod 7”. The same can be accomplished by working on the base value as well, Lets see it. Since “7” took 18 part of the division of the value of “14” by “2” then “14” and “7” can be used for 19 the base value as well. The value of “2” is too low for any use and we'll skip it, although it is a base value for the duo of “5” and “3”, never the less.

Lets take the base value of “14” and work it out by first raising the duo shadows, next, adding “14” to “5” and we get “19” and by adding “14” to “3” we get “17”. Now we have “19 mod 14” and “17 mod 14” by changing the base value, we've changed the range of the values that can for enciphering as well, since they start from “1” to the base value “14” minus “1” and it is “13”, now we can encipher and decipher values in the range of “1-13”.

The values enciphered with the base value of “14” can be deciphered by the base value of “7” as well, the only difference is, if we're using the base value of “14” and deciphering it with the base value of “7” the range of the enciphered values are from “1” to “6” and not from “1” to “13”. That is the reason that the base value of “2” could not be used, since the range for it would've been from “1” to “1”, which means only the number “1”. In case the top base value is used for enciphering and its lower composite used for deciphering, the enciphering value must be “1” less than the lower base value used in the process.

Reviewing the triplet values we come to the conclusion that “3×5=7×2+1; 5 mod 7 [symbol] 3 mod 7; 12 mod 7 [symbol] 10 mod 7; 19 mod 14 [symbol] 17 mod 14; 19 mod 14 [symbol] 17 mod 7; 17 mod 14 [symbol] 19 mod 7; 19 mod 14 [symbol] 17 mod 2; and 17 mod 14 [symbol] 19 mod 2″ and so on; the “ [symbol] ” means that the result from one side of the equation once applied to the other side will produce the same end result.

In the previous example, if we were using it in as a asymmetric schema, we certainly would've have had a big security problem, since on two values were use for the base values “2 and 7” and their byproduct of “14”, all an eavesdropper would have need to do was to divided the byproduct “14” by dividing it by “2” and derive “7” and make known the private deciphering key. It wouldn't matter if the byproduct was raised to a very high value, still it would've been revealed by a simple division, the solution is the next topic of our discussion.

This time around, Lets do the opposite to find multiple base values and it works just the inverse when we found the triplet-shadow values for the symmetric schema, there is, we will find multiples base value for the shadow values. We already know that to have a triplet-shadow values we need to have an equal equation and the base value to be one less the product of the duo-shadow values; based on this knowledge we can say that the base value is its product plus one.

Lets take three values, “5”, “7” and “9”, once again, it can be any value, or a combination of odd and even values, odds are always good candidates and primes are the best candidates. The product of “5”, “7” and “9” is “315” and once we add the value of “1” to we have “316” and by dividing “316” by “2” we get “158”; “316” is dividable by “4” as well and the result is “79”. We conclude that “79 mod 315 [symbol] 4 mod 315” produces the same result as “158 mod 315 [symbol] 2 mod 315” and by adding the base “315” value to the duo-shadow values we get “(315+59) 394 mod 315 [symbol] (315+4) 319 mod 315” and “(315+158) 473 mod 315 [symbol] (315+2) 317 mod 315” respectively. The best practice is always to use prime numbers and after adding one to the multiplication value to derive the two shadows and keep dividing until a prime value is reached, the same applies once deriving the base value from the two shadows' values.

Based on what we already know we conclude that now we have an asymmetric schema with three public keys for each value base of the two triplets and they can encipher values from “1” to “4” since the smallest of the three values is “5”; following are the enciphering and deciphering keys:
1) Enciphered values for “394 mod 315” can be deciphered with “319 mod 315; 319 mod 5; 319 mod 7 and 319 mod 9”.
2) Enciphered values for “319 mod 315” can be deciphered with “394 mod 315; 394 mod 5; 394 mod 7 and 394 mod 9”.
3) Enciphered values for “473 mod 315” can be deciphered with “317 mod 315; 317 mod 5; 317 mod 7 and 317 mod 9”.
4) Enciphered values for “317 mod 315” can be deciphered with “473 mod 315; 473 mod 5; 473 mod 7 and 473 mod 9”.

The value of “2” is a base value as well, we didn't include it because only the values of “1” will be able to be used for the enciphering and deciphering processes.

Now any of the values with the original values of “5”, “7” and “9” can be given to three different persons without the possibility of anyone reversing any of the other keys since once the product “315” value is divided by the individual's key (5, 7 and 9) the result will be the product of at least two other keys, in our example we're using three keys, it can be any number of keys. Although the current schema is not yet perfect, it will be enhance once we explain multiple bases.

The above schema is a good way for a group of people to securely communicate but it still has a drawback and a solution as well. The drawback is based on the product of the base key being used for enciphering and deciphering as well and as is it cannot be used for asymmetric key where the public key needs to be published and in use by the general public.

Here goes the solution. As we've seen before, we know that once exponentiation is applied to the base value it can be used for enciphering but not for deciphering since the result contains the product of all the base vales and each of the base value as well, and once deciphering is applied to the value after its exponentiation the end result will still have the byproduct and each value of the base values as well.

After exponentiation is applied the base value along with their byproduct, they can be used for enciphering/deciphering, one value of the base can be used as public key and yet another one as the private keys, it will be explained further later on.

### Shadows and Bases

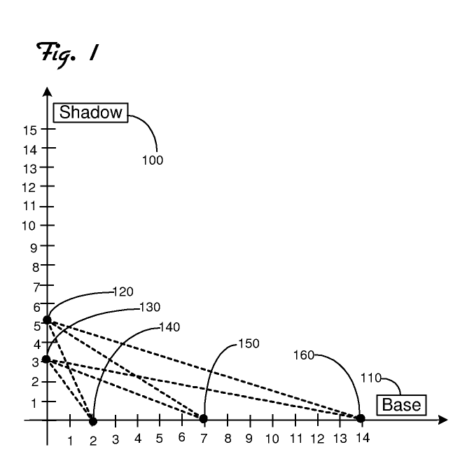

Lets now turn our attention to FIG. 1 and it illustrates the shadow 100 and its values “5” 120 and “3” 130; on the opposite axis the base 110 and its corresponding values as well, and they are: “2” 140, “7” 150 and “14” 160. In our illustration the value “5” 120 and the value of “3” 130 and they are used for the shadow 100 and once they are multiplied their product will be “15” and once the value of “1” is subtracted from, the value of “14” is thus produced 160. Next, the value of “14” 160 is divided by “2” 140 and the result is “7” 150. Every value that takes part of the division will be a base for the two shadows' values and as we analyze, the value of “2” 140 is a shadow as well.

Each of the base value will be able to encipher/decipher from the value of “1” to the base value minus “1”. As well, the enciphering of the higher value can 17 be deciphered by any of the lower bases values. Once again, the only limitation 18 is the range that is limited to the base minus “1”. For instance, if the value of “14” 160 is used to encipher the deciphered values will be “1-13” and it will be the values of “1-6” for the base “7” 150 and “1” for the base “2” 140.

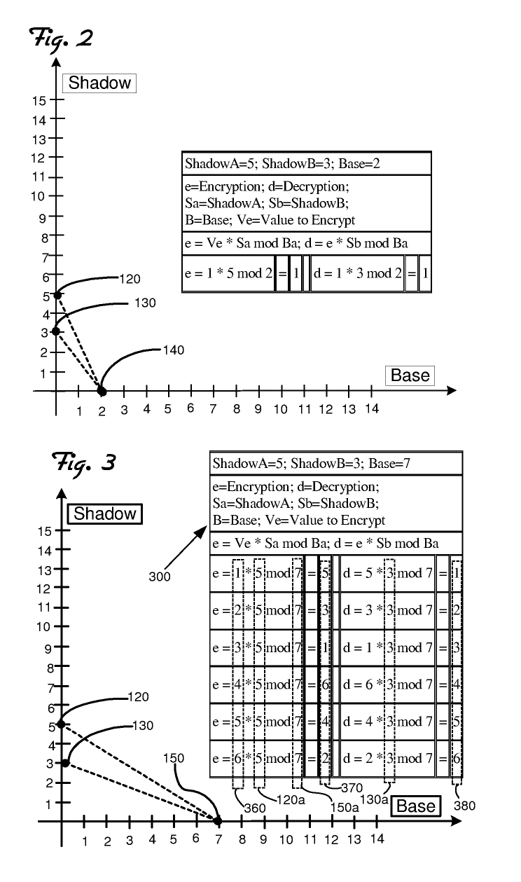

Lets now turn our attention to FIG. 2 and illustrates the first base 140 and it is the base “2” and since it can only encipher and decipher the value of “1” it can be ignored all together. Lets proceed to FIG. 3 and it illustrates the base for the value of “7” and as we review its accompanying table 300 and it has three columns. Column 120a represents the shadow value of “5” 120; column 150a represents the base value of “7” 150 and column 130a represents the shadow value of “3” 130. Now, columns 360 illustrates the input values to the equation; column 370 is the output of the first equation, and column 380 the original value after it is applied through the second equation.

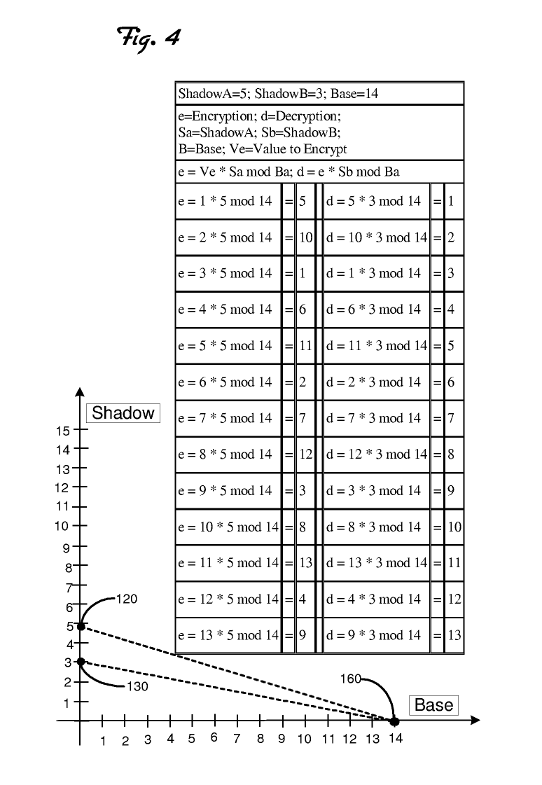

As we now turn our attention to FIG. 4 and it illustrates the base value of “14” 160 for the shadows' value of “5” 120 and “3” 130. The same explanation for FIG. 3 applies here as well and anyone with the skill of the art will be able to follow the explanation already given and understand its meanings as well.

### Multiple Shadows

As aforementioned a single shadow has more than one base and what the higher base value enciphers can be deciphered with a lower base value the values that can be deciphered are from “1” to the base value taking part of the deciphering minus “1”. We'll be back to this subject once again later when we explain multiple bases used in public key encryption.

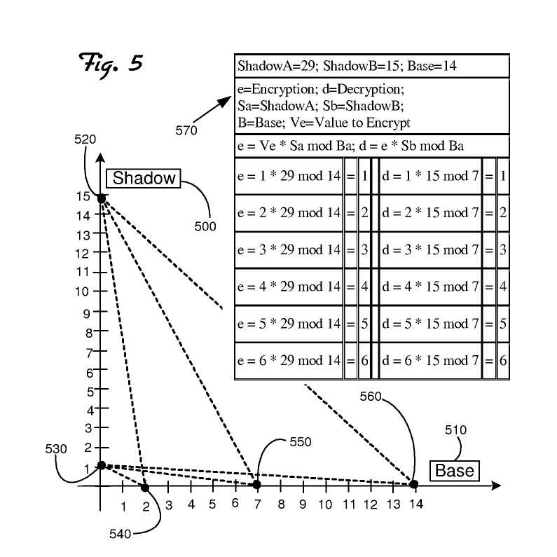

Lets now turn to FIG. 5 and illustrates one more shadow that we've left out from the original explanation and we did it that way for sake of simplicity. As with the bases where we saw that each value participating in process became part of the base, the same is true with the shadows and “15” 520 and “1” 530 are shadow-pair as well for the bases “2” 540, “7” 550 and “14” 560; “15” 520 and “1” 530 are a shadow-pair because each value starts with the value of “1” and the product of the two original shadow-pair is “15”. As we might notice, the shadow-pair of “15” and “1” can't be used for enciphering and deciphering, since each sides of both equations will produce the same value as the starting value without producing any change and that is illustrated at the table 570 with the base value of “14” added to both shadow values thus producing “29” and “15”.

As per our last example of which was illustrated on FIG. 5, we now know that every value participating in the shadow side will form a shadow. In the previous examples we used the values “3” and “5” to derive the shadows “14”, “7” and “2” it was illustrated that for one shadow we had multiple bases. The same is true for the shadow. Lets include one more value “7” to the shadow “3” and “5” and now we have three values for the multiple shadows. Now we have a few combinations that can be used for enciphering/deciphering. We have “3”, “5” and “7” or any of their product.

The only difference with shadows in relation to the bases is that if we encipher with one value all other values must take place in the deciphering. Lets take “3” for instance to encipher, the values of the base pair of “5” and “7”, or, their product “35” must be used for deciphering and vice versa, if the value of “35” is used to encipher the value of “3” must be used to decipher. Regarding the base it still will function as before, the higher values can be used in the enciphering process and the lower values in the deciphering.

As it has been illustrates in the explanation of the previous drawings, each shadow value creates a shadow with another value and in the case of the highest and the lowest values they can be disregarded because they don't producing enciphering/deciphering. Proceeding with our explanation. If we multiply “3”, “5” and “7” we get “105, once we subtract “1” one from we get “104”. By dividing it with any value that it is dividable with, in regarding to “104” the value of “2” and we'll get “52”, as keep dividing it by “2” we get “26” and finally we get “13” and it is the last value of the shadow, the last because it is a prime number. We can stop dividing the base at any time without having to reach its lowest value. The base produces the combinations for enciphering/deciphering along with the used shadow-value pair.

Now, the shadow value of “5” can be used to encipher with any of the base values and the value of “21” will be the shadow value used for deciphering what was enciphered with the value of “5”, or the combination of “7” and “3”. Lets take an example. Lets encipher the value of “6” with the base value of “13”. “6*3 mod 13=5=>5*5 mod 13=12=>12*7 mod 13=6”; now with a combination of shadow values, first with the shadow value of “3” and lastly with the product of shadow values of “5” and “7” and it is “35”: “6*3 mod 13=5=>5*35 mod 13=6”. The above arrangement can be used for enciphering a message that must be deciphered by two or more recipients at the same time.

Lets say Bob has a message for Bruce and Alice and both must be able to read the message or none can read it. Bob may encipher with the value of “e=message*3 mod 113” then sends to Bruce the values of “7” and “10”, and to Alice he sends to Alice the values of “5” and “3” along with the enciphered message. Once they both receive it, they will add the base values and produce the value of “3+10=13” then multiply the shadow values and produce “7*5=35”, now they both can decipher the enciphered message with: “message=e*35 mod 13”.

All the previous explanations regarding adding the base value to shadow values apply here as well. Lets do it now by adding the shadow value of “13” to the other shadow values. “13+3=16 and 13+35=48”, proceeding, “6*16 mod 13=5=>5*48 mod 13=6”, the values can be raised to their power as well, lets do it: “16̂2=256, 35 ̂2=1225 and 13̂2=169”, lets now encipher the value of “6”: “6*256 mod 169=15=>15*1225 mod 13=6”, enciphering is done with the base raised to the same power as the shadow's values and deciphering is done with the base in its primitive value. In the above example Bob could have sent to Bruce the values of “400” and “10” and to Alice the values of “324” and “3”. Bob could have enciphered the message with: “e=message*256 mod 169”, Alice and Bruce could have deciphered it with: “message=e*129600 mod 13”.

The above example can be used for other means as well, like, in signature dispensing apparatus where a number of people must be authorized before allowing the signing of checks, for instance. In a company the president may sign checks alone, but if he is not present, at least two vice presidents will be needed to dispense a signature in a check. In the above example, the president may have a card with the combinations “3, 5 and 7”, one vice present a card with the combinations of “5 and 7” and the other vice president will have a card with the combinations of “7 and 3”, one last one will have a card with the combinations of “3 and 5”. The apparatus can be programmed to ignore repeated combinations and the key is to reproduce the base values. Since the only card that will be able to dispense a signature alone is the president's card, all others will need two or more cards.

### Multiple Bases and Public Encryption

Lets continue with the original shadow values of “3” and “5”, and the base value of “7”. And now we will add the base value to the shadows' values: “7+5=12 and 7+3=10”, next, we raise their respective values to the power of “2”: “12{circumflex over ())}{circumflex over (})}2=144, 10̂2=100 and 7̂2=49”. It can be raised to any value; we're using the value of two since it is a small value and for easy understanding. As we already know, we can encipher with: “e=message*100 mod 49” and decipher with: “message=e*144 mod 7”, or, encipher with: “e=message*144 mod 49” and decipher with: “message=e*100 mod 7”.

Once again, this schema can be used for public encryption if the recipient will only receive enciphered message and not reply to any of them. If this is the case, then one the enciphering-key pair can be the public key and the other deciphering-key pair the private key. As well, it can be used for two-way encryption where each party will exchange their respective public keys.

Although it lacks the ability for enciphering and decipher both ways as it is required by the public encryption schemes. We will further elaborate the scheme and produce a two-way public encryption that follows next.

Lets produce the next key pair to be used by the public to decipher enciphered messages sent by the sender to the group (public) possessing the public key. In our example the public have the base value raised to its power and its value is “49”, we also know that this is done to increase security. Now, lets produce another base value from the value of “49” and since we already know that any of the value participating in the base will produce a shadow corresponding values, as well we know that, any value of the base can be used for the purpose of enciphering and deciphering.

Now, we will be using the value of “2” since it already has been used in the base, it can be any value as well, without departing from the true teaching of this invention. Lets produce another base value by multiplying “2” with the value of “49” and we get the value of “98” and now we add the value of “1” to and get “99”, now, the value of “99” can be divided by “9” producing the shadow-value pair of “9” and “11”. Lets proceed and add the new base to the shadow's values and we get “98+9=107” and “98+11=109”. Once again lets raise them all to the power of “2” and we get: “107̂2=11449”, “109̂2=11881” and “98̂2=9604”.

We can now give one of the two shadow keys to the public, lets give away “11449” and keep “11881”. The public can encipher with the keys: “e=message*144 mod 49” and decipher with: “message=e*11449 mod 49”; the private key owner will encipher with: “e=message*11881 mod 9604” and decipher with: “message=e*100 mod 7”. Lets elaborate it with a real example, the only limitation is that the enciphered values will be from “1” to “6” from the public side since the lowest base value is “7” and the values of “1” to “48” from the private side since the base value is “49”, of course, in a real world application larger values would have been used.

Public Key Example:
m=message to be enciphered
e=enciphered message
sve=enciphering shadow (private)
svd=deciphering shadow (private)
bve=enciphering base (private)
bvd=deciphering base (private)
spe=enciphering shadow (public)
spd=deciphering shadow (public)
bp=base (public)
Owner encipher with (Private Key):
   e=m*sve mod bve
   m=5
   e=5*11881 mod 49=17
Public decipher with (Public Key):
   m=e*spd mod bp
   m=17*11449 mod 49=5
Public encipher with (Public Key):
   e=m*spe mod bp
   m=5
   e=5*144 mod 49=34
Owner decipher with (Private Key):
   m=e*svd mod bvd
   m=34*100 mod 7=5

### Multiple Bases/Shadows Certified Email Solution

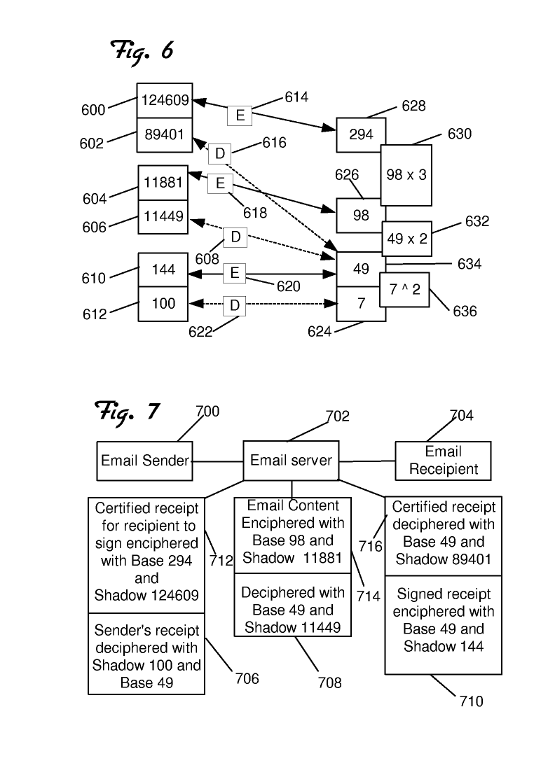

As we now turn our attention to FIG. 6 and it illustrates what we've described above and the bottom we have base “7” 624 and its deciphering shadow “100” 612 along with its companion enciphering shadow “144” 610 and its base “49” 634. Bases “49” 634 is a product for the raised power of “2” 636 with the base “7” 624. Base “49” is multiplied by “2” 632 and the new base “98” 626 and its two companion shadows “11881” 604 and “11449” 606.

As we've aforementioned, base “7” 624 and shadow “100” 612 are the deciphering private key 622 and base “49” 634 along with shadow “144” 610 the enciphering public key 620. Base “98” 626 along with shadow “11881” 604 are the enciphering private key 618 and base “49” 634 along with shadow “11449” 606 the deciphering public key 608.

Further above we have a new base value “294” 628 and it is the product of the previous base “98” 626 multiplied by “3” 630 and it is the base for shadow “124609” 600 and shadow “89401” 602. The shadow value “124609” 600 is “294” added to the shadow “195” which is “294+59=353” and raised to the power of “2” and it is “353̂2=124609”, the same applies to the lower shadow value “89401” 602 which is the shadow value of “5” and the value of “294” added to it “294+5=299” and raised to the power value of “2” and it is “299̂2=89401”.

As we can see, any number of bases and shadow can be implemented, throughout we've multiplied a value to a base value to derive the new base value, it is but one way, it can be raised to the power of any value, multiplied, etc.

Lets proceed and describe a use for the above arrangement where a plurality of bases and having a plurality of accompanying shadows. As we turn our attention now to FIG. 7 and it illustrates an email system having means to certify emails for both senders and recipients. An email can be a single email or an archive (attachment) with multiple documents and the can be separate or compressed as a single archive file.

Once email sender 700 sends an email to the email recipient 704; email server 702 creates the enciphering mechanism of FIG. 6 and assigns it to the email 708/714. Email server 702 issues a certified receipt 712 to the email sender 700, just like in a Post Office when a piece of certified mail is presented to the Post Office's agent and the agent stamps a receipt certifying that a piece of certified mail has been presented for delivery to a recipient.

Now the certified receipt 712 is enciphered with the base “294” 628 and shadow “124609” 600—top—(the enciphering can be just an electronic signature, electronic stamp, etc.) and once the recipient receives the certified receipt 716, it can be deciphered with base “49” 634 and shadow “89401” 602, this will complete the first part of the transaction.

Next, if the recipient 704 accepts the email 708/714, a new receipt 710 with an electronic signature like “/signature/” is issued and it will be enciphered with the base “49” 634 and the shadow “144” 610 and emailed to email sender 700. Email sender 700 will decipher the certified receipt 706 with the shadow “100” 612 and base “7” 624.

Following, the email 714 is enciphered with base 98 626 and shadow 11881 604. After the email recipient 704 accepts the email 708 and the certified receipt 710 is sent to the email recipient 700, the recipient 704 can decipher the email 708 with the base “49” 634 and shadow “11449” 606.

As we might notice, the above arrangement can be used differently as well, it can be used without the top key 628, 600 and 602, if it is implemented this way, then the sender will not receive an enciphered receipt. It is illustrated as is to show the many possibilities that this present invention has to offer and it is only limited by the human imagination.

Furthermore, a combination of sender's private/public key pair can be used along with the email system provided key combinations, for instance, the receipt that the sender will receive from the email server or any kind of server that the solution is implemented therewith, we're using email server for our exemplary explanation for this embodiment of this present invention, the receipt can have an electronic stamp can be enciphered with one of the shadow/base key and an electronic signature enciphered with the system's (email server) private key shadow/base pair and the sender will view the stamp using the public key shadow/base pair from the server and the signature from the server's public key shadow/base combination.

This arrangement can be implement using a software program where all of the above exchange is done automatically. The idea is the same one used in a physical Post Office whence certifying email, except, this process is done over the Internet or a local network where correspondences are certified and only the intended recipient will be able to accept and read their contents. The recipient cannot deny that he/she receive the certified email, sine a receipt for the transaction is present and only one piece of email will have the enciphering and the deciphering means (shadow/base combination keys) to encipher and decipher the transaction.

Additionally, every user registered with the email server can have a private and public key assigned automatically at the registration time and the receipts' signatures can be electronically signed by using the private key of the email recipient enciphering the recipient's signature and the certified receipt encrypted with the sender's public key. Once the sender receive the receipt, the sender's public key is used to decipher the receipt and the recipient's public deciphering key used to decipher the recipient's signature, this way the recipient cannot deny the he/she didn't accept the enciphered electronic message, email in our example. Once again, the email can be a single or a group of electronic messages compressed in any available file format or PDF (Portable Data Format), ZIP compression format, etc., as well, the message can be sent to a single or a group of individuals using the same described methodology.

Furthermore, the electronic messages can be enciphered with the recipient's public key and the sender's signature enciphered with the sender's private key, and the just mentioned process will take place once the recipient's receive the enciphered message, he/she will decipher with his/hers public key and decipher the signature with the sender's public deciphering key, the process works the same way as when signing the certified receipt. The just mentioned email system using one or more arrangement of the shadow numbering system described throughout the disclosure of this invention can be implemented differently without departing from the true spirit of this invention. As well, a key to identify the email sent/received can be developed and incorporated, like a database key or receipt serial number for tracking the certified email, not shown for sake of simplicity; the idea is that it will function just like the Postal Service certified mail system.

The more we analyze the present invention the more uses become apparent. For instance, it can be used for protecting a network/Internet communication, password transfer within insecure communication channel and one more example will help us to visualize the incredible potential it has to offer. This time around it will be used for securing data in a server and it can be any kind of server, email server, database server, etc. Lets say that it is implemented once a user register with a server, lets take the email server for our example, it is but one use, it can be used for other kind of servers and computers as well, like, laptop, desktop, etc., we'll be using an email server in our example.

### Registered Users Shadow Encryption

Once a user registers with the email server two keys are generated and assigned to the user, a private and a public one. They both can be saved on the server or the private key given to the registered user, in case it is given to the registered user, every time he/she logs in a file with it can be uploaded (provide in any conceivable way) to the server along with a password and have the user authenticated this way. If they both are saved on the server, then the user password can be used to mask the private key pair, the masking can be another encryption means or just an XOR with the private key and the password. After this mechanism is implemented then all communication, email in our example, will be enciphered with the recipient public key and the recipient will decipher with the private key, any electronic signing is enciphered with the sender's private key and the revealing of it is done by deciphering it with the sender's public key. This can be implemented in a way that will be transparent to all users.

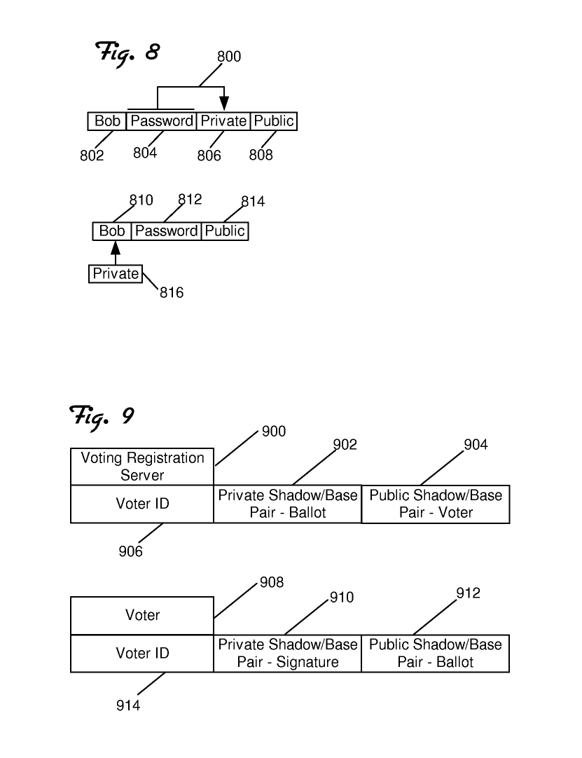

As we now turn our attention to FIG. 8 and it illustrates a registered user and the user id is “Bob” 802 and his password 804 masking 800 the private key 806 and the public key 808 is unmasked. This arrangement can be used with any kind of private key solution and not necessarily exclusive with the shadow/base solution that we've described so far. The second arrangement the user “Bob” 810 has in his private possession his private key 816 and it can in his desktop computer, laptop computer, removable drive, CD ROM, etc.

In the first arrangement once Bob signs in with the system the system will use his password to unmask the private key and make use of it for Bob's transactions. It can be saved on a user session for the duration of the user interaction with the system's computer. The second arrangement Bob 810 will provide his private key 816 at login time and his password 812 will be used to authenticate him with the server and his private key 816 can be saved on a session variable for the duration of his interaction with the system and the system's server will make use of his public key 814 as it would've done with the first arrangement.

### Voter Registration Using Shadow Encryption

By turning our attention to FIG. 9 and it illustrates one more arrangement where the shadow encryption solution can be used to enhance lives in every segment of society. This time around we'll be illustrating a voting system solution where it will safely and inexpensively secure voting online over the Internet or over a Network.

It is illustrated the Voting Registration Server 900 and it having the Voter ID 906 and a Private Shadow/Base Pair assigned to the voter's ballot 902 and a Public Shadow/Base Pair assigned to the voter 904 and it is assigned to Voter ID 906. Other information like a voter password can be present as well, not illustrated for sake of simplicity and not intent to obscure the present invention. Once voter 908 logs in with the Voting Registration Server 900 a voting ballot will be sent to Voter 908 and it will be related to Voter ID 906 and 914. Now, once voter 914 votes two things will happen, first, the voter's signature (electronic) 914 will be enciphered with the Private Shadow/Base Pair 910 and the Voting Server 900 will use the Public Shadow/Base Pair 904 to decipher the electronic signature and make sure that the proper voter has done the voting. The confirmation can be base on a secrete phrase, name, question, answer, etc., that only the voter will know and has been pre-assigned to the voting server 900 by the voter 908. After the voter finishes voting the voting ballot will be enciphered with the Public Shadow/Base Pair 912 on the voter 908 side and after it is received by the voting server 900, the voter registration server 900 will decipher it with the private key pair 902 of the public key 912.

The few illustrates arrangements are just a few ways that can be implemented using the shadow-base numerical system, many more can be devised and implemented without departing from the true spirit of this invention, the above teaching offers unlimited use for this invention, and its use is only limited to the human imagination.

### Enciphering/Deciphering Apparatus

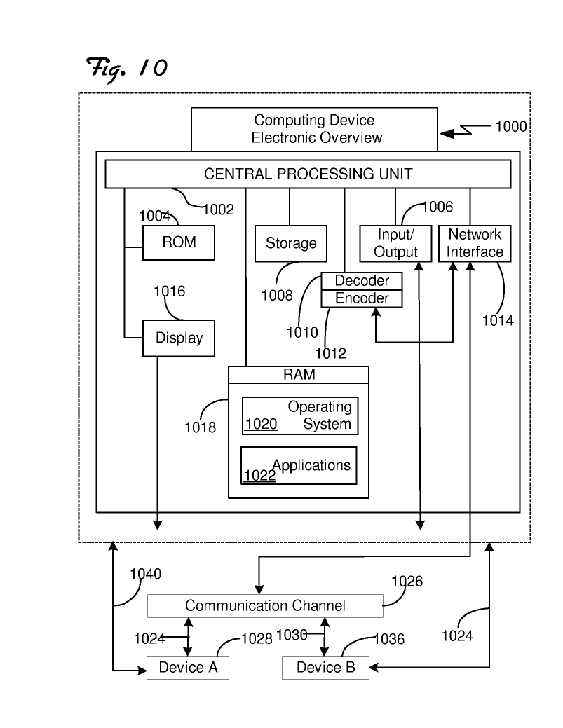

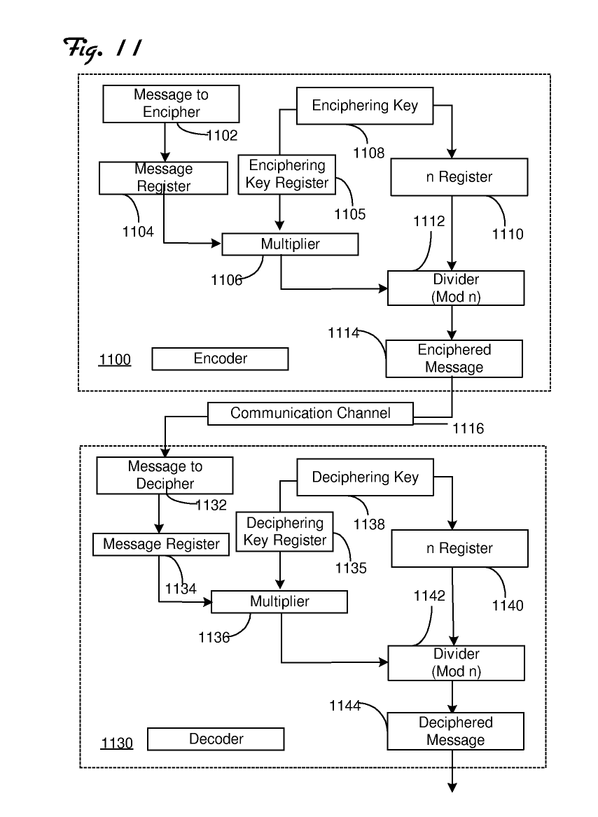

As we now turn our attention to FIG. 10 and it illustrates an apparatus for enciphering and deciphering text messages. Any information in its original format is called plain text and once it is encrypted, that is, its value is changed to an unreadable form that is very difficult to produce its original form without the proper key, it is called enciphered or encrypted text, the process of using the proper key value to reproduce its original text is called deciphering or decrypting.

The enciphering/deciphering apparatus 1000 of FIG. 10 illustrates a CPU (Central Processing Unit) 1002 and it is the brain of the device and once the device (apparatus) is first turned on it will fetch code stored in its ROM (Read Only Memory) 1004 and as the code instructions are processed, it will instruct the CPU 1002 to read other code data from storage 1008 and it can be any kind of storage device like but not limited to: disk unit, removable storage unit, flash memory, etc., and store it into RAM (Read Access Memory) 1018.

The data code can be OS (Operating System) 1020 and/or applications program 1022. The application program can be any kind of program like program code to process the computing of the enciphering and deciphering of data depicted herein and if it is code instruction dealing with enciphering/deciphering the CPU 1002 will access the encoding unit 1012 for enciphering data and decoding unit 1010 for deciphering data. As the enciphering/deciphering happens the enciphering/deciphering process will make use of the network interface 1014.

As the device 1000 communicates with the outside world, the network-interfacing device 1014 will use communication channel 1026 and it can but not limited to: wired, wireless networks, radio link, etc. The communication channel 1026 is a non-secured communication-channel means and the communication between device B 1036 and device A 1028 are protected by the electronic circuitry of each device (encoder/decoder) and each device will have at least, all or some of the electronic elements depicted for device 1000.

The device 1000 will have means to communicate with a user using the device like a keypad and other interfacing elements and is done through the 10 (Input Output) port 1006. Device 1000 also has means for presenting information to a user through its display 1016 and it can be any kind of information, including but not limited to: numerical display, graphical display, LED (Light Emitting Diode) display, etc.

As we've described for FIG. 10, device 1000 has encoder 1012 and decoder 1010 and they are used for the enciphering and deciphering of information at a single device or in between two or more devices. As we now turn our attention to FIG. 11 and it illustrates electronic block for decoder 1010 (FIG. 10) and it is the encoder 1100 and for encoder 1012 (FIG. 10) it is decoder 1130.

Messages to encipher 1102 are placed one byte at a time on the message register 1104 and the enciphering key 1108 (shadow) which is in the enciphering key register 1105 along with the message to encipher 1102 that is in the message register 1104 are shifted into the multiplier 1106. Now, the enciphering key 1108 (base) is placed into the n Register 1110 and shifted into the divider (Mod n) 1112 along with the output from multiplier 1106, multiplier 1106 and divider 1112 can be a single unit, as needed, other units can be implement on the same unit as well like but not limited to: a unit do add and another unit to subtract. Once the data is output from divider 1112 it will be the enciphered message 1114.

Once again, the encoding unit 1100 and the decoding unit 1130 can be in a single device or in two separate devices without departing from the true spirit of this invention. After the enciphered message 1114 leaves device 1000 (FIG. 10) though its network interface/communication port 1014 (FIG. 10) it will travel the communication channel 1026 and it is the same communication channel 1116 FIG. 11. For the sake of our explanation lets say that encoder 1100 is at device A 1024 and decoder 1130 is at device B 1036 (FIG. 10).

After the enciphered message 1114 leaves the sender device A 1024 (FIG. 10) and travels the communication channel 1116 (1026—FIG. 10) and reaches the receiving device B 1036 (FIG. 10) the deciphering of the enciphered message will starts at the decoding unit 1010 (FIG. 10) will begin. At the decoder 1130 the message to decipher 1132 is placed into the message register 1134 and the deciphering key 1138 (shadow) is placed into the deciphering key register 1135 the two are shifted into the multiplier 1136. The deciphering key 1138 (base) is placed into the n Register 1140 and once the output from multiplier 1136 is received by the divider (mod n) 1142 the deciphering of the enciphered message 1114 will occur and the output from divider (mod n) 1142 will the deciphered message 1144, plaintext message, thus, the cycle from enciphering to deciphering messages.

### Solving Puzzles With Shadow Numbers

The Post Office Puzzle—Lets show some examples, using the shadow-numbering system and we will use the Post Office puzzle and it goes like this: “There was a Post Office in a country and it was very corrupt, any valuable that would be sent on the mail system would be opened and the valuables removed, but any box with a lock on it would not be messed with.

Bob lived on one city and Alice lived on another city on the other coast of that country, they couldn't get together and Bob wanted to propose Alice. Bob called Alice and they devised a scheme. Bob would place the ring in a box and place a lock on it and keep the key, then send it to Alice, once Alice received the box she would place another lock on the box and send it back to Bob, so they did. Once Bob received the box with the two locks, he removed his lock and sent it back to Alice, once Alice received it she removed her lock from the box and got the ring.”

Solving this puzzled using the shadow-numbering system is easy, lets do it! The Post Office is the transporting system and the box with the locks and the ring inside is the shadow-triplet values. We'll be using the shadow-triplet values of “3,5” and base “7”.
1) R=ring and it is the value of “3”.
2) B=box and it is the value of “7”.
3) Bob=picks the shadow value of “3” and his lock value is “2”.
4) Alice=picks the shadow value of “5” and her lock value is “3”.
5) Bob=3*3=9=>9+2 mod 7=4=>he sends “4” to Alice.
6) Alice=4*5=20=>20+3 mod 7=2=>she sends “2” to Bob.
7) Bob=2*3=6=>6-2 mod 7=4=>he sends “4” to Alice.
8) Alice=4*5=20=>20−3 mod 7=3—she now has the ring and it is the value of “3”.

Lets redo the above puzzle and this time around we'll be subtracting the values, instead. The lock values will be changed as well to accommodate subtraction. Bob will use “4” for his lock, Alice will pick “2” for hers.
1) R=ring and it is the value of “3”.
2) B=box and it is the value of “7”.
3) Bob=picks the shadow value of “3” and his lock value is “4”.
4) Alice=picks the shadow value of “5” and her lock value is “2”.
5) Bob=3*3=9=>9−4 mod 7=5=>he sends “5” to Alice.
6) Alice=5*5=25=>25−2 mod 7=2=>she sends “2” to Bob.
7) Bob=2*3=6=>6+4 mod 7=3=>he sends “3” to Alice.
8) Alice=3*5=15=>15+2 mod 7=3—she now has the ring and it is the value of “3”.

Well, Bob and Alice became so cleaver that they decided to communicated using the new found algorithm to fool the Post Office. Lets see now how Bob would send “love” to Alice. All characters will be converted to numerical values, “a”=“1”, “b”=“2”, . . . “z=26”, etc. The values of the character set table representing the enciphered characters can be used as well. Bob will add the values of “4, 3, 2, 1” starting from the letter “1” 4 is added to; “o” 3 is added to, etc; and Alice will subtract the values of “1, 2, 3, 4” starting from the letter “I”. We'll be using the triplets of “17”, “2” and base “33”, we'll will add the base's value to the shadow's values and they will be: “50”, “35”.
9) Message=“love”=“12 15 22 5”
10) Base=“33”
11) Bob=picks the shadow value of “50”.
12) Alice=picks the shadow value of “35”.
13) Bob=sends “10 27 13 20” to Alice.
14) Alice=sends “19 19 23 3” to Bob.
15) Bob=sends “22 23 26 17” to Alice.
16) Alice=“12 15 22 5¢—she now has the word of “love”.

The values can be raised to power as well as long two bases are used, for instance, the shadow's could've been: “2500” and “1225” and Bob's base “1089”, as long as the recipient keeps the original base, the value of “33”, Alice in this case, all will work the same. An eavesdropper will have to guess all the masking values to each value being enciphered by sender and receiver. The above algorithm will have a great deal of use in open channel communication, since the enciphering key can be masked and be used to encipher the actual message, the enciphering key can be XORed on the message and it will be a much faster way than the currently available means. The initial process can happen at the handshake time of the initial communication, as well, it can be used to transmit a password in an insecure communication channel. Other means can be devised and new uses implemented without departing from the true scope and spirit of this invention.

The aforementioned arrangement can be used in Smart Cards where the user will login into the server over insecure communication channel passing the disguised password (masked both ways like it was illustrated for the word “love”) and the enciphering key assigned to the Smart Card holder for the duration of the session without ever compromising the Smart Card, that is, the Smart Card will never have the enciphering keys therein and in case it is lost, stolen or compromised there will be no way for its illegitimate use nor the deciphering of data stored therein.

A secondary key can be assigned to the Smart Card just for the purpose of saving its data therein, the secondary key will always be stored in a safe server where the user access, then after the user authentication using the masked password means, the secondary key is transmitted to, and used by the Smart Card for the purpose of enciphering and deciphering data stored therein. As well, another key used for enciphering the communication, or still, a single key can be used for both purposes. In case two separate keys are used, then the communication-enciphering key may be runtime-server generated for the duration of the user's interaction session.

With the above two-puzzle solution, we've presented a new way of using the shadow numbering system. We've used it to add values to the first puzzle and to subtract values from the second puzzle. The solution is the same. The two puzzles just presented can be used for two-way encryption similar to Diffie-Hellman's algorithm to exchange a private key using smaller values in which will be a great improvement, since an array with all values can be passed each way and the values will always be masked without any possibility of and eavesdropper being able to decipher them, then have the private key used for the enciphering/deciphering process.

One more. If all swans are white and we come across a black swan, is it still a swan? Lets take the notion of the puzzle. The question is if they both are swan then they must be able to crossbreed and reproduce gray swans. If it is the case, then the two swans will end up multiplying them into the new gray swans. Lets say that the black swan is of the opposite sex of the white swan, in any way, if all swans are white than the black swan will eventually be able to meet a mate of the opposite sex. That being the case, if the two swans reproduce two—male and female—every year and their offspring—gray swans—produce two—male and female—every year for five years in the end of five years there will be sixty two gray swans from the black and white swans. Then the two shadow values represent the black and white swans, once they are multiplied and the new shadow used with the companion value of one, we'll get the answer of the table of FIG. 5 and it illustrates the two species in a linear progression. The colors of the descendant swans do not necessary need be of gray color, it is just an assumption, of course.

So far, we've presented solutions where the shadow-side values are used for producing the base side values and vice-versa. Basically, any value can be used and since every value has a shadow companion value, even the case with prime numbers, the same works for the base side, that is, any value can be used on the base side since it will have at least one companion value, and again, this applies to prime numbers.

Base on these principles, there are other uses where a single shadow value can be used to derive its base, as well, there are case where a single base value can be used to derive its shadows. Lets see it next by solving some more puzzles.

The Two Opposite Travelers—Two travelers will journey from point A to point B. One will start from point A toward point B and the other from point B toward point A. They both can travel at any speed, they both will make their journeys in one hour and they will cross each other along their journeys.

Since we know some facts, lets review them. Their distance is the same, the time that will take them to start and finish is the same, they journey in the opposite direction and they will cross each other. We start with the base value and it can be any even value, lets pick “10”. Now we'll add one to the base to get the forward traveler's direction and subtract one from the base to get the reverse traveler's direction (See Table #1).
1) Ta=traveler A (forward—A to B).
2) Tb=traveler B (reverse—B to A).
3) D=the base distance between the two and it is “10”.
4) Ta=D+1=>Ta=10+1=11.
5) Tb=D−1=>Tb=10−1=9.

They meet in the middle and the value is “5”.

TABLE #1

| | | | |
|---|---|---|---|
| Ta = 1 * 11 mod 10 = | 1 | Tb = 1 * 9 mod 10 = | 9 |
| Ta = 2 * 11 mod 10 = | 2 | Tb = 2 * 9 mod 10 = | 8 |
| Ta = 3 * 11 mod 10 = | 3 | Tb = 3 * 9 mod 10 = | 7 |
| Ta = 4 * 11 mod 10 = | 4 | Tb = 4 * 9 mod 10 = | 6 |
| Ta = 5 * 11 mod 10 = | 5 | Tb = 5 * 9 mod 10 = | 5 |
| Ta = 6 * 11 mod 10 = | 6 | Tb = 6 * 9 mod 10 = | 4 |
| Ta = 7 * 11 mod 10 = | 7 | Tb = 7 * 9 mod 10 = | 3 |
| Ta = 8 * 11 mod 10 = | 8 | Tb = 8 * 9 mod 10 = | 2 |
| Ta = 9 * 11 mod 10 = | 9 | Tb = 9 * 9 mod 10 = | 1 |

Lets reverse their positions, that is, lets look in the reverse of their starting points. Since the previous puzzle we've started with the point of view of traveler A's starting point, to reverse we need to place the base in the point of view of traveler B's starting point. To do that we'll add the base to the traveler B's, subtract one from the traveler A's and the base will be changed to the reverse point of view, that is, to traveler B's point of view (See Table #2).
1) Ta=traveler A (reverse—B to A).
2) Tb=traveler B (forward—A to B).
3) D=the base distance between the two and it is “10”.
4) Ta=D−1=>Ta=10−1=9.
5) Tb=D+Ta=>Tb=10+9=19.

TABLE #2

| | | | |
|---|---|---|---|
| Ta = 1 * 19 mod 10 = | 9 | Tb = 9 * 9 mod 10 = | 1 |
| Ta = 2 * 19 mod 10 = | 8 | Tb = 8 * 9 mod 10 = | 2 |
| Ta = 3 * 19 mod 10 = | 7 | Tb = 7 * 9 mod 10 = | 3 |
| Ta = 4 * 19 mod 10 = | 6 | Tb = 6 * 9 mod 10 = | 4 |
| Ta = 5 * 19 mod 10 = | 5 | Tb = 5 * 9 mod 10 = | 5 |
| Ta = 6 * 19 mod 10 = | 4 | Tb = 4 * 9 mod 10 = | 6 |
| Ta = 7 * 19 mod 10 = | 3 | Tb = 3 * 9 mod 10 = | 7 |
| Tb = 8 * 19 mod 10 = | 2 | Ta = 2 * 9 mod 10 = | 8 |
| Tb = 9 * 19 mod 10 = | 1 | Ta = 1 * 9 mod 10 = | 9 |

There are other ways of producing differentiating values from the shadow triplets. Lets give some more.

Moving both shadows forward (See Table #3).
1) Sa=shadow A.
2) Sb=shadow B.
3) B=base.
4) Sa=B+1.
5) Sb=1.
6) B=10.
7) Sa=10+1=11.

TABLE #3

| | | | |
|---|---|---|---|
| Sa = 1 * 11 mod 10 = | 1 | Sb = 1 * 1 mod 10 = | 1 |
| Sa = 2 * 11 mod 10 = | 2 | Sb = 2 * 1 mod 10 = | 2 |
| Sa = 3 * 11 mod 10 = | 3 | Sb = 3 * 1 mod 10 = | 3 |
| Sa = 4 * 11 mod 10 = | 4 | Sb = 4 * 1 mod 10 = | 4 |
| Sa = 5 * 11 mod 10 = | 5 | Sb = 5 * 1 mod 10 = | 5 |
| Sa = 6 * 11 mod 10 = | 6 | Sb = 6 * 1 mod 10 = | 6 |
| Sa = 7 * 11 mod 10 = | 7 | Sb = 7 * 1 mod 10 = | 7 |
| Sa = 8 * 11 mod 10 = | 8 | Sb = 8 * 1 mod 10 = | 8 |
| Sa = 9 * 11 mod 10 = | 9 | Sb = 9 * 1 mod 10 = | 9 |

Moving both shadows backwards (See Table #4).
1) Sa=shadow A.
2) Sb=shadow B.
3) B=base.
4) Sa=B+1.
5) Sb=1.
6) B=10.
7) Sa=(B*2)−1.

TABLE #4

| | | | |
|---|---|---|---|
| Sa = 1 * 19 mod 10 = | 9 | Sb = 9 * 1 mod 10 = | 9 |
| Sa = 2 * 19 mod 10 = | 8 | Sb = 8 * 1 mod 10 = | 8 |
| Sa = 3 * 19 mod 10 = | 7 | Sb = 7 * 1 mod 10 = | 7 |
| Sa = 4 * 19 mod 10 = | 6 | Sb = 6 * 1 mod 10 = | 6 |
| Sa = 5 * 19 mod 10 = | 5 | Sb = 5 * 1 mod 10 = | 5 |
| Sa = 6 * 19 mod 10 = | 4 | Sb = 4 * 1 mod 10 = | 4 |
| Sa = 7 * 19 mod 10 = | 3 | Sb = 3 * 1 mod 10 = | 3 |
| Sa = 8 * 19 mod 10 = | 2 | Sb = 2 * 1 mod 10 = | 2 |
| Sa = 9 * 19 mod 10 = | 1 | Sb = 1 * 1 mod 10 = | 1 |

### Overview

To create a base we start with two or more values by multiplying them and subtracting one from the product's result. Then divide the base by any dividable value that it is dividable with. All the values taking part on the base side will be a base value for the shadow's value-pair.

Any value on the base side can be used for enciphering and deciphering. If a value is enciphered with a value the deciphering can be done with any lower-base value. The enciphering starts with the value of one and up to the base value minus one.

On the shadow side one value is used to produce the enciphering values along with the base value and the other shadow's value is used along with one of the base values (the same used for enciphering or a lower one) for deciphering.

The shadow can have multiple values and if it has, if one is used to encipher, all others or their product, will have to take place in the deciphering process.

Two or more values can take place on the creation process of bases. All the participating values are multiplied and one added to their product, then divide it with any value that can be divided with and the two values becomes the shadow for the base group.

Base values can be added to itself and to other shadow's values participating with the base. The base and the participating shadow's can be raised to a power value and the same value must be used for the triplet. If the triplet is raised to the power of another value, then one shadow-raised value is used along with the base-raised value and they become the public enciphering key, the other shadow-raised value along with the base value in its original form without being raised to the power of another number, become the private deciphering key.

To produce two-way public key enciphering schema, after the base and shadow's values are raised to the power of another value, multiply any value to the base-raised value add one to it then divide the result with any other value, one of the new shadow's value along with the new base value will be the private enciphering key, the other shadow's value will be the public deciphering key along with the first base-raised value.

Any value used on the shadow side will have at least one shadow companion value and at least two other values as the supporting base. If a value is not dividable by any other value on the shadow side it will have the value of one for its shadow companion, the same is true on the base side, if it is not dividable by any other value, it will have one as the base companion, these scenarios are the case of prime-numbers values. In either case whenever they only have one as a companion value the shadow cannot be used for the process of enciphering nor deciphering, since the same value that is applied on any of the equations will simply reproduce itself, thus, lonely prime numbers are poor values for producing shadows.

The enciphering value is multiplied with one of the shadow's value then the modulus taken with the base value, the deciphering will used the previous result and multiply it with the other shadow value and have the modulus taken with the base value, thus, reproducing the deciphered value from the enciphered one.

As well, this invention can be used in the enciphering and deciphering in any environment, it can be but not limited to: network, Internet, air communication, wired, wireless, archive, in a single apparatus, multiple apparatus, etc.

Basically, any value can be used on the base side to produce differing shadow's direction and for solving puzzles. The process always involves a common modulus value that is common to two other values and once one of the modulus of one of the values is taken with the base value and its result applied (multiplied) with the other value and the modulus is taken again with the base value, the original or other intended value is reproduce. The common modulus is the base and the other values are the shadow of the base.

When creating a base for the shadows and dealing with public key schemes, it is best to have a prime number since it will only produce a single base value. Throughout our examples we've shown small values, it is well known to those of the skill in the art that in real world application very large prime numbers and other values are used and the process of reverting the keys are infeasible without the knowledge of the equivalent private key pair of the public key.

As it is well know to those of the skill in the art of cryptography, the information to be enciphered can be composed in two (diagraph) or more character and have them composition of character ciphered as a block, block ciphering. This is a way of producing increased security than by ciphering a single character. It hasn't been explained here for sake of simplicity and not intended in any way to obscure the means, scope and use of the present invention.

A method and an apparatus have been taught and a means for transmitting a key/password over insecure channel without the possibility of the deciphering of its content by an eavesdropper. A first signal containing the key/password to be transmitted is transposed with an additional random signal value and the intended signal along with the random signal is transmitted to the receiver and the receiver will transpose a second random signal and return to the sender the two random signals along with the intended signal's message. The sender will remove the first random signal that was inserter by said sender apparatus and transmit the second random signal along with the intended signal's message, upon receiving the two remaining signals the receiver will remove the second random signal that as transposed by said receiver and the intended signal's message is retrieved.

The described embodiments of this invention can be used for other purposes as well besides the ones illustrated herein or combined to form other embodiment without departing from the true spirit and teaching of the present invention. Once the masking technique is used like in solving the of the puzzle where sender and recipient mask the message can be used for transferring a shadow and a base to the recipient then the communication be enciphered using the transparent key. It will greatly enhance communication security between personal device like cellular telephony, PDA, and the like since they lack computational power required with other security solutions. Furthermore, when we said that it could be used along with Diffie-Hellman's algorithm to produce the transparent shadows then the base, it can be a single value and create the shadow-pair from the base instead. As well, since the enciphering values limitation rely on the base value, once a large value for the base is derived, then a block cipher can take place and it can marked as “/start-block/” for starting a block “/end-block/” for ending a block, or, “/block-1/; /block-2/; . . . /block-n/”, or any other conceivable way. The base value don't necessarily needs to be two values, it can be a single value and the value of “1” added to it and its result divided by any value that it can be divided with, this is true in the case of a prime number value.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A method for enciphering and deciphering data using shadow numbers, comprising:
at least two values and said at least two values are called shadow-pair values;
said at least two shadow-pair values are multiplied and the value of “1” is subtracted from the product of said multiplication;
the result of said subtracted value is divided by at least one value that it can be divided with and said at least one value is called the base value;
a value to encipher; and
said value to encipher participates in a first multiplication operation with one value of said shadow-value pair as the first shadow value and a first modulus operation of the product of said first multiplication operation is taken with said base value or any value that is a composite of said base value deriving the enciphered value.

2. The method according to claim 1 wherein base value is added to said two shadow-value pair.

3. The method according to claim 1 wherein at least one value of said two shadow values is a prime value.

4. The method according to claim 1 wherein said base value or a composite of said base value is a prime value.

5. The method according to claim 1 further comprising:
said enciphered value participates in a second multiplication operation with the other value of said shadow-value pair that didn't participate in said first multiplication operation; and
a second modulus operation is taken between the product of said second multiplication operation and said base value or any value that is a composite of said base value deriving a deciphered value and it is the value of said value to encipher.

6. A method according to claim 5 wherein said enciphering process is accomplished by solving:
e=ve*se mod b;
wherein e is said enciphered value;
wherein ve is said value to encipher;
wherein se is said enciphering shadow value;
wherein b is said base value or any composite of said base value;
wherein the deciphering of the enciphered value is accomplished by solving:
vd=ve*sd mod b;
wherein vd is said deciphered value;
wherein ve is said enciphered value;
wherein sd is said deciphering shadow value; and
wherein b is said base value or any composite value of said base value.

7. A method for enciphering and deciphering data using shadow numbers, comprising:
at least two values and said at least two values are called first shadow-value pair;
said at least two first shadow-value pair are multiplied and the value of “1” is subtracted from the product of said multiplication;
the result of said subtracted value is divided by at least one value that it can divided with and said at least one value is called the first base value;
said first base value is added to each of said first shadow-pair value;
said first base value and said first two-shadow value pair are raised to the power of a common value producing two raised first shadow-values pair and one raised first base value;
a first value to encipher; and
said first value to encipher participates in a first multiplication operation with one value of said first raised shadow-value pair and a first modulus operation of the product of said first multiplication operation is taken with said first raised base value or any value that is a composite of said first raised base value deriving the first enciphered value.

8. The method according to claim 7 wherein at least one value of said two shadow values is a prime value.

9. The method according to claim 7 wherein said first base value or any composite of said base value is a prime value.

10. The method according to claim 7 further comprising:
said first enciphered value participates in a second multiplication operation with the other value of said raised first shadow-value pair that didn't participate of the first multiplication operation; and
a second modulus operation is taken between the product of said second multiplication operation and said first base value or any value that is a composite of said first base value deriving a first deciphered value and it is the value of said first value to encipher.

11. The method according to claim 10 further comprising:
an additional value is multiplied to said raised base value and producing a second base value; and
the value of “1” is added to said second base value;
the result of said addition is divided by any value that it can be divided with and at least two values of said division are the second shadow-value pair.

12. The method according to claim 11 further comprising:
said second base value is added to said second shadow-value pair; and
said second shadow-value pair are raised to the power of a common value producing two raised second shadow-pair values.

13. The method according to claim 12 further comprising:
a second value to encipher;
said second value to encipher participates in a third multiplication operation with one of said raised second shadow-value pair; and
a third modulus operation of the product of said third multiplication operation is taken with said second base value or any value that is a composite of said second base value deriving the second enciphered value.

14. The method according to claim 13 further comprising:
said second enciphered value participates in a fourth multiplication operation with the other of said raised second shadow-value pair that didn't take part of the enciphering operation of said second enciphered value; and
a fourth modulus operation is taken between the product of said fourth multiplication operation and said first raised base value deriving a second deciphered value and it is the value of said second value to encipher.

15. A method according to claim 14 wherein said enciphering process for said first value to encipher is accomplished by solving:
e1=ve1*se1 mod be1;
wherein e1 is said first enciphered value;
wherein ve1 said first value to encipher;
wherein se1 is said first enciphering shadow value;
wherein be1 is said first enciphering base value or any composite value of said enciphering base value;
wherein the deciphering of said enciphered first value is accomplished by solving:
vd1=e1*sd1mod bd1;
wherein vd1 is said first deciphered value;
wherein e1 is said first enciphered value;
wherein sd1 is said first shadow deciphering value;
wherein bd1 is said first deciphering base value or a composite value of said enciphering base value;
wherein said enciphering process for said second value is accomplished by solving:
e2=ve2*se2 mod be2;
wherein e2 is said second enciphered value;
wherein ve2 is said second value to encipher;
wherein se2 is said second enciphering shadow value;
wherein be2 is said second enciphering base value or any composite value of said enciphering base value;
wherein said deciphering process of said enciphered second value is accomplished by solving:
vd2=ve2*sd2 mod bd2;
wherein vd2 is said second deciphered value;
wherein ve2 is said second enciphered value;
wherein sd2 is said second deciphering shadow value; and
wherein bd2 is said second deciphering base value or any composite value of said deciphering base value.

16. A method for enciphering and deciphering data using shadow numbers, comprising:
at least two values and said at least two values are called base values;
said at least two base values are multiplied and the value of one added to said multiplication and the result of said addition is divided by any value that it can be divided with and at least two values of said division are a shadow-value pair;
a value to encipher; and
said value to encipher participates in a first multiplication operation by one of said shadow-value pair as the first shadow value and a first modulus operation is taken between the product of said first multiplication operation and at least one value of said base value or any value that is a composite of at least one of said base values deriving the enciphered value.

17. The method according to claim 16 wherein at least one value of said two base values is added to said two shadow-value pair.

18. A method according to claim 16 wherein at least one of said base value or any composite value of said base value is a prime value.

19. A method according to claim 16 wherein at least one of said shadow value or any composite value of said shadow value is a prime value.

20. A method according to claim 16, further comprising:
said enciphered value participates in a second multiplication operation with another value of said shadow-value pair that didn't participate on the enciphering process of said enciphered value; and
a second modulus operation is taken between the product of said second multiplication operation and at least one value of said base value or any value that is a composite of said base value deriving the deciphered value and it is the value of said value to encipher.

21. A method according to claim 20 wherein said enciphering process is accomplished by solving:
e=ve*se mod b;
wherein e is said enciphered value;
wherein ve is said value to encipher;
wherein se is said enciphering shadow value;
wherein b is said base value or any composite value of said base value;
wherein the deciphering of said enciphered value is accomplished by solving:
vd=ve*sd mod b;
wherein vd is said deciphered value;
wherein ve is said enciphered value;
wherein sd is said deciphering shadow value; and
wherein b is said base value.

22. A method for enciphering and deciphering data using shadow numbers, comprising:
at least two values and said at least two values are called shadow-value pair;
said at least two shadow-value pair are multiplied and the value of one is subtracted from the product of said multiplication and the result of said subtraction is divided by any value that it can be divided with and at least one values of said division is called a shadow-value pair;
a value to encipher;
said value to encipher participates in a first multiplication operation with one of said shadow-value pair as a first shadow value; and
a first random value participates in a first mathematical operation with said product of said first multiplication operation, wherein said first mathematical operation is an addition and a first modulus operation is taken between the result of said first mathematical operation and said base value or any value that is a composite of said base value deriving a first enciphered value.

23. The method according to claim 22 further comprising:
said first enciphered value participate in a second multiplication operation with the other value of said shadow-value pair that didn't participate at said first multiplication operation as a second shadow value; and
a second random value participates in a second mathematical operation with the product of said second multiplication operation, wherein said second mathematical operation is an addition and a second modulus operation is taken between the result of said second mathematical operation and said base value or any value that is a composite of said base value a second enciphered value.

24. The method according to claim 23 further comprising:
said second enciphered value is multiplied as a third multiplication operation with said shadow-value pair that participated at said first multiplication operation;
said first random value participates in a third mathematical operation with the product of said third multiplication operation, wherein said third mathematical operation is a subtraction of said first random value from the product value of said third multiplication operation; and
a third modulus operation is taken between the result of said third mathematical operation and said base value or any value that is a composite of said base value deriving the third enciphered value.

25. The method according to claim 24 further comprising:
said third enciphered value participate in a fourth multiplication operation with said shadow-pair value that participated at said second multiplication operation;
said second random value participates in a fourth mathematical operation with the product of said fourth multiplication operation, wherein said fourth mathematical operation is a subtraction of said second random value from the product of said fourth multiplication operation; and
a fourth modulus operation is taken between the result of said fourth mathematical operation and said base value or any value that is a composite of said base value deriving a deciphered value and it is the value of said value to encipher.

26. A method according to claim 25 wherein the enciphering of said first value is accomplished by solving:
e1=((ve*s1)+r1)mod b;
wherein e1 is said first enciphered value;
wherein ve is said value to encipher;
wherein s1 is said first shadow value;
wherein r1 is said first random value;
wherein b is said base value;
wherein the enciphering of said second enciphered value is accomplished by solving:
e2=((e1*s2)+r2)mod b;
wherein e2 is said second enciphered value;
wherein e1 is said first enciphered value;
wherein s2 is said second shadow value;
wherein r2 is said second random value;
wherein b is said base value;
wherein the enciphering of said third enciphered value is accomplished by solving:
e3=((e2*s1)−r1)mod b;
wherein e3 is said third enciphered value;
wherein e2 is said second enciphered value;
wherein s1 is said first shadow value;
wherein r1 is the first random value;
wherein b is said base value;
wherein the deciphering of said third enciphered value is accomplished by solving:
vd=((e3*s2)−r2)mod b;
wherein vd is said deciphered value;
wherein e3 is said third enciphered value;
wherein s2 is said second shadow value;
wherein r2 is said second random value; and
wherein b is said base value.

27. A method according to claim 25 wherein said first mathematical operation and said fourth mathematical operations are both subtraction operations;
wherein said second and said third mathematical operations are both addition operations;
Wherein the enciphering of said enciphered value is accomplished by solving:
e1=((ve*s1)−r1)mod b;
wherein e1 is said first enciphered value;
wherein ve is said value to encipher;
wherein s1 is said first shadow value;
wherein r1 is said first random value;
wherein b is said base value;
wherein the enciphering of said first enciphered value is accomplished by solving:
e2=((e1*s2)+r2)mod b;
wherein e2 is said second enciphered value;
wherein e1 is said first enciphered value;
wherein s2 is said second shadow value;
wherein r2 is said second random value;
wherein b is said base value;
wherein the enciphering of said second enciphered value is accomplished by solving:
e3=((e2*s1)+r1)mod b;
wherein e3 is said third enciphered value;
wherein e2 is said second enciphered value;
wherein s1 is said first shadow value;
wherein r1 is the first random value;
wherein b is said base value;
wherein said deciphering operation of said third enciphered value is accomplished by solving:
vd=((e3*s2)−r2)mod b;
wherein vd is said deciphered value;
wherein e3 is said third enciphered value;
wherein s2 is said second shadow value;
wherein r2 is said second random value; and
wherein b is said base value.

28. A method according to claim 25 wherein said second mathematical operation and said third mathematical operations both are subtraction operations; wherein said first and said fourth mathematical operations are both addition operations;
wherein then enciphering of said value to encipher is accomplished by solving:
e1=((ve*s1)+r1)mod b;
wherein e1 is said first enciphered value;
wherein ve is said value to encipher;
wherein s1 is said first shadow value;
wherein r1 is said first random value;
wherein b is said base value;
wherein the enciphering of said first enciphered value is accomplished by solving:
e2=((e1*s2)−r2)mod b;
wherein e2 is said second enciphered value;
wherein e1 is said first enciphered value;
wherein s2 is said second shadow value;
wherein r2 is said second random value;
wherein b is said base value;
wherein the enciphering of said second enciphered value is accomplished by solving:
e3=((e2*s1)−r1)mod b;
wherein e3 is said third enciphered value;
wherein e2 is said second enciphered value;
wherein s1 is said first shadow value;
wherein r1 is said first random value;
wherein b is said base value;
wherein the deciphering of said third enciphered value is accomplished by solving:
vd=((e3*s2)+r2)mod b;
wherein vd is said deciphered value;
wherein e3 is said third enciphered value;
wherein s2 is said second shadow value;
wherein r2 is said second random value; and
wherein b is said base value.

29. The method according to claim 22 wherein at least one value of said two shadow values is prime value.

30. The method according to claim 22 wherein said base value or a composite of said base value is a prime value.

31. A method for enciphering and deciphering data using shadow numbers, comprising:
at least two values and said at least two values are called shadow-value pair and having at least one additional value and said additional value is called the base value and it is the common modulus with said at least two shadow-value pair wherein once a value to encipher participates with the first multiplication operation with one value of said two shadow-value pair and the first modulus operation of said first multiplication operation's product is taken with said base value a first enciphered value is derived; and once said first enciphered value participate in a second multiplication operation with the other value of said shadow-value pair that didn't take part of the first enciphering process and once a second modulus operation of the product of said second multiplication operation is taken with said common base value the deciphering of said enciphered value is derived and it is said value to encipher before it was enciphered by the first multiplication operation.

32. The method according to claim 31 further comprising:
a value is multiplied with said base value and at least one additional base value is derived, said at least one additional base value will have at least two additional shadow-value pair.

33. A method for enciphering and deciphering data using shadow numbers, comprising:
at least two values and said at least two values are called shadow-value pair and having at least one additional value and said additional value is called the base value and said base value participates in a modulus operation with each of said at least two shadow-value pair;
a value to encipher; wherein said value to encipher participates with the first multiplication operation with one value of said two shadow-value pair deriving a first product and a first additional value participate on a first mathematical operation with said first product value deriving a first residue value, the first modulus operation of said first residue value is taken with said base value deriving a first enciphered value, said first enciphered value having a residue of said first additional value and a residue of said value to encipher;
said first enciphered value participate in a second multiplication operation with the other value of said shadow-value pair that didn't take part of said first multiplication operation, a second additional value participates in a second mathematical operation with said second product value deriving a second residue value, a second modulus operation of said second residue value is taken with said common base value and a second enciphered value is derived, said second enciphered value having a residue of said value to encipher, a residue of said first additional value and a residue of said second additional value;
said second enciphered value participates in a third multiplication operation with said shadow-value pair that produced said first enciphered value and a third product value is derived and said first additional value participates on a third mathematical operation with said third product value deriving a third residue value, a modulus is taken between said third residue value and said base value deriving a third enciphered value, said third enciphered value having a residue of said value to encipher and a residue of said second additional value; and
said third enciphered value participates in a forth multiplication operation with said shadow-value pair that produced said second enciphered value deriving a forth product value, said second additional value participates on a fourth mathematical operation with said fourth product value deriving a fourth residue value, a modulus is taken between said fourth residue value and said base value deriving a deciphered value and it is said value to encipher before it participated on said first multiplication operation.
